(19) United States
(12) Patent Application Publication
(10) Pub. No.: US 2019/0219037 A1
(43) Pub. Date: Jul. 18, 2019

(54) POWER GENERATING SYSTEM OPERATED BY GRAVITY

(71) Applicant: Te-Chih CHANG, New Taipei City (TW)

(72) Inventor: Te-Chih CHANG, New Taipei City (TW)

(21) Appl. No.: 15/921,042

(22) Filed: Mar. 14, 2018

(30) Foreign Application Priority Data
Jan. 12, 2018 (TW) 107101190

(51) Int. Cl. F03G 3/00; F03G 7/10

(52) U.S. Cl. CPC F03G 3/00; Y10S 74/09; F03G 7/10

(57) ABSTRACT

The present invention discloses a power generating system operated by gravity, which is a self-perpetuating system achieved by gravity to enable mass to result in a moment of force to convert into energy, with the energy being then fed back to the system to assist in the dynamic operation, and redundant energy being able to work outward to generate electricity. The system includes a central shaft to support plural load brackets which are mechanisms in a long shape and are distributed radially and isotropically. Each load bracket is provided with a counterweight unit which displaces along a longitudinal centerline according to the action of gravity.

### BACKGROUND OF THE INVENTION

### a) Field of the Invention

The present invention relates to a power generating system operated by gravity, and more particularly to a self-perpetuating system achieved by gravity to enable mass to result in a moment of force, with that the moment of force is converted into energy which is then fed back to the system to assist in the dynamic operation, and that redundant energy can output electricity outward.

### b) Description of the Prior Art

An operating system which gyrates about a center of circle, such as a fan, will result in a torque on the axis through the push from an external force. If the external force, which is wind power or hydropower, keeps going, then the torque will output power as the working time increases.

Regarding energy development, the issue now is the environmental protection and the natural energy can be converted into electricity by a wind-driven power generating system, a hydropower system, a tidal power generating system or solar panels. However, the abovementioned methods for utilizing the natural energy are limited inherently by the geographic conditions, such as a wind field, a reservoir storing water, a sea area with tidal range, or a field with long time exposure in sunlight.

### SUMMARY OF THE INVENTION

The primary object of the present invention is to provide a power generating system operated by gravity. The system enables mass to result in a moment of force to convert into energy by gravity, at any time, any place and under any climate, with that redundant energy can be converted into electricity. The system comprises a central shaft, the axis of which is parallel to the horizontal line. The central shaft supports plural load brackets to gyrate, with that the load brackets are mechanisms in a long shape and are distributed radially and isotropically. An interior of each load bracket is slidingly and longitudinally provided with a counterweight unit. Depending upon the variation in the angular position of the load bracket, the counterweight unit changes the relation of the force arm with respect to the load bracket, resulting in an effective moment of force at the angular position which is under an explicit influence by gravity, so that a power output shaft can generate an effective torque.

Another object of the present invention is to provide a power generating system operated by gravity, wherein the power output shaft can be connected outward to an energy conversion unit which can feed back to the system with energy used to adjust the counterweight unit, with that redundant energy can work outward, such as generating electricity.

A third object of the present invention is to provide a power generating system operated by gravity, wherein the counterweight unit is a circular body with an axis. The counterweight unit is rotatably assembled on a lead screw which is fixed on a center of the load bracket longitudinally, and a circumference on the largest radius of the lead screw is provided with a passive structure driven by a driving unit disposed on a slide bar, forming the largest force moment to rotate the counterweight unit.

A fourth object of the present invention is to provide a power generating system operated by gravity, wherein the system is provided with a sensing or control device to sense the change in the angle of rotation of each load bracket.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a schematic view of an operation mechanism of the present invention.

FIG. 2 shows a schematic view of structural relation that a counterweight unit is linked by a driving unit, according to the present invention.

FIG. 3 shows a schematic view of relation that the counterweight unit is combined with a load bracket, according to the present invention.

FIG. 4 shows a schematic view of structure that the driving unit is linked with the counterweight unit, according to the present invention.

FIG. 5 shows a schematic view, illustrating that a variation in an angular position of the counterweight unit changes the length of force moment, according to the present invention.

FIG. 6 shows a schematic view of a center structure of the system, according to the present invention.

FIG. 7 shows a graph of path along which the counterweight unit changes the angular position, according to the present invention.

FIG. 8 shows another graph of path along which the counterweight unit changes the angular position, according to the present invention.

FIG. 9 shows still another graph of path along which the counterweight unit changes the angular position, according to the present invention.

FIG. 10 shows a schematic view of an auxiliary application to inertia, according to the present invention.

### DETAILED DESCRIPTION OF THE PREFERRED EMBODIMENTS

A power generating system operated by gravity, disclosed by the present invention, enables mass to result in a moment of force to convert into energy by gravity, with that redundant energy can output electricity outward.

Please refer to the descriptions of drawings hereinafter for the detailed structures and the working principles of operation of the present invention. First of all, it should be noted that as the proportion of the system structure is extremely high, a part of elements in the drawings is only illustrated briefly.

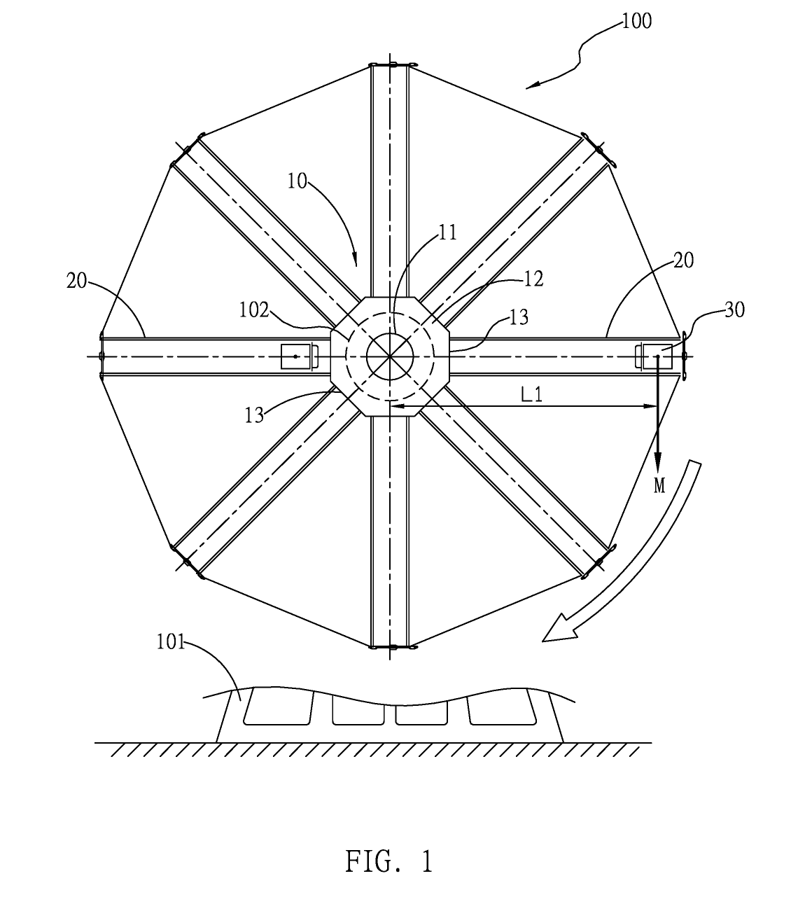

Referring to FIG. 1, an operation mechanism 100 is provided with a central shaft 11. The central shaft 11 is supported by an upright base 101 that the axis of the central shaft 11 is parallel to the horizontal line on ground. The entire system is installed on the ground, and the central shaft 11 provides for the emplacement of a wheel pivot 12, so that the wheel pivot 12 can gyrate. The wheel pivot 12 is radially and isotropically distributed with plural load brackets 20 through a combination part 13. The load bracket 20 is a mechanism in a long shape and is provided longitudinally with a centerline. The longitudinal centerline of each load bracket 20 is slidingly provided with a counterweight unit 30, and the counterweight unit 30 results in a moment of force toward the wheel pivot 12 by gravity. The effect is like that when a load bracket 20 is at the direction of 3 o'clock, a longest force arm L1 is formed between the mass M of the counterweight 30 of the load bracket 20 and the center of the central shaft 11, so that a torque can be generated on the wheel pivot 12 and is output outward from a power output shaft 102.

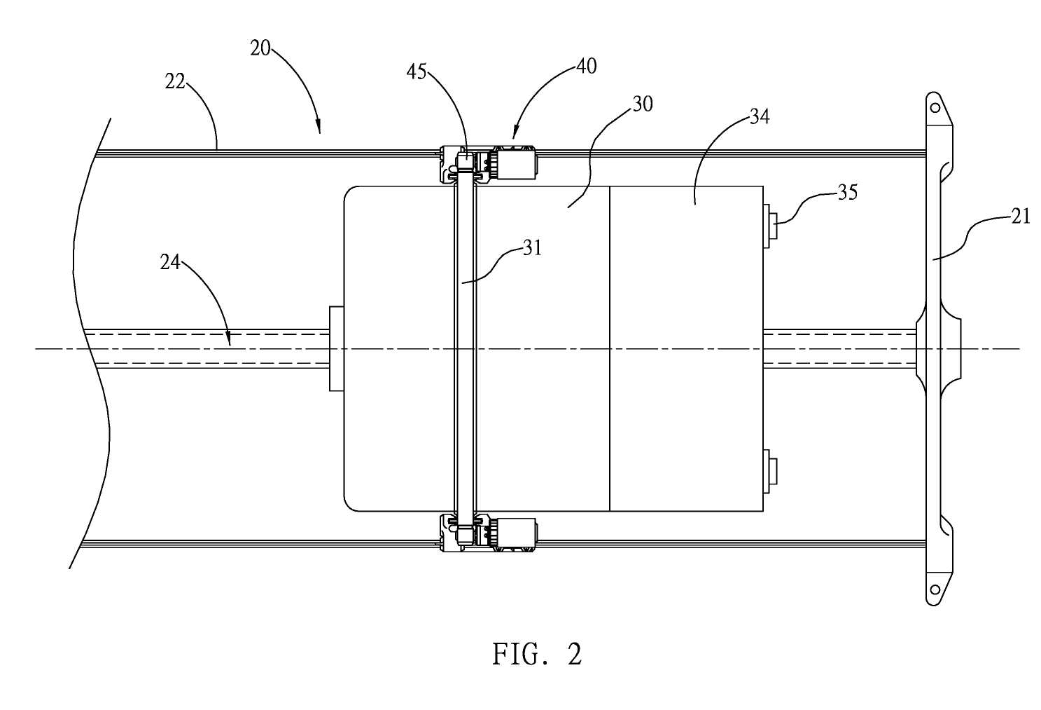

Referring to FIG. 2, the load bracket 20 provides for the counterweight unit 30 to be disposed slidingly along the longitudinal centerline. A center of the counterweight unit 30 is assembled and connected by rotation with a lead screw 24 which is fixed on the longitudinal centerline of the load bracket 20. In addition, the center of the counterweight unit 30 gyrates about the lead screw 24. However, due to the lead pitch function, the front and rear position of the counterweight unit 30 on the longitudinal centerline will be adjusted and the counterweight unit 30 can displace longitudinally.

The counterweight unit 30 is a circular body and is provided with some mass by itself. However, to accumulate the counterweight, an additive counterweight 34 can be assembled on one end of the counterweight unit 30 additively. The additive counterweight 34 is fixed onto the body of the counterweight unit 30 by a fixing element 35.

An outer end of the load bracket 20 is fixed and combined with a seal end 21. A center of the seal end 21 fixes the other end of the lead screw 24, and a side of the seal end 21 fixes the opposite end of the load bracket 20. At least a side of the load bracket 20 is provided with a slide bar 22 which is combined with the lead screw 24 to form an infrastructure of the load bracket 20. The slide bar 22 provides for a driving unit 40 to be disposed slidingly. An output wheel 45 of the driving unit 40 acts onto a circular passive structure 31 formed by a largest radius of the counterweight unit 30, wherein the output wheel 45 and the passive structure 31 are linked together by gnawing with gear teeth.

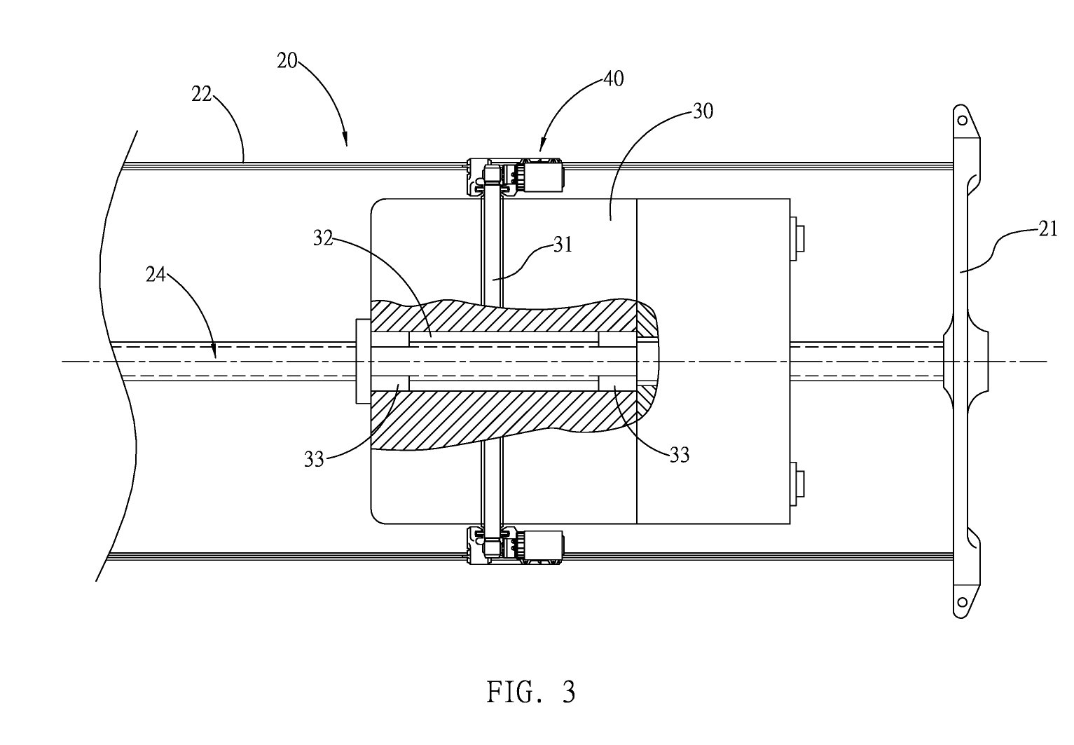

Referring to FIG. 3, a center of the counterweight unit 30 is a hollow part 32. A front end and a rear end of the hollow part 32 are provided respectively with a whirling screw 33 which is connected by rotation with the lead screw 24; whereas, to increase the sliding ratio of the whirling screw 33, threads of a ball bead can be used to rotate with respect to the lead screw 24.

Two longitudinal sides of the load bracket 20 are provided symmetrically with two slide bars 22, and each slide bar 22 can be assembled with a driving unit 40. By the symmetry, the two driving units 40 can act force together onto the passive structure 31 of the counterweight unit 30 on the opposite sides, which reduces the loss of force arm of the counterweight unit 30 that is linked radially.

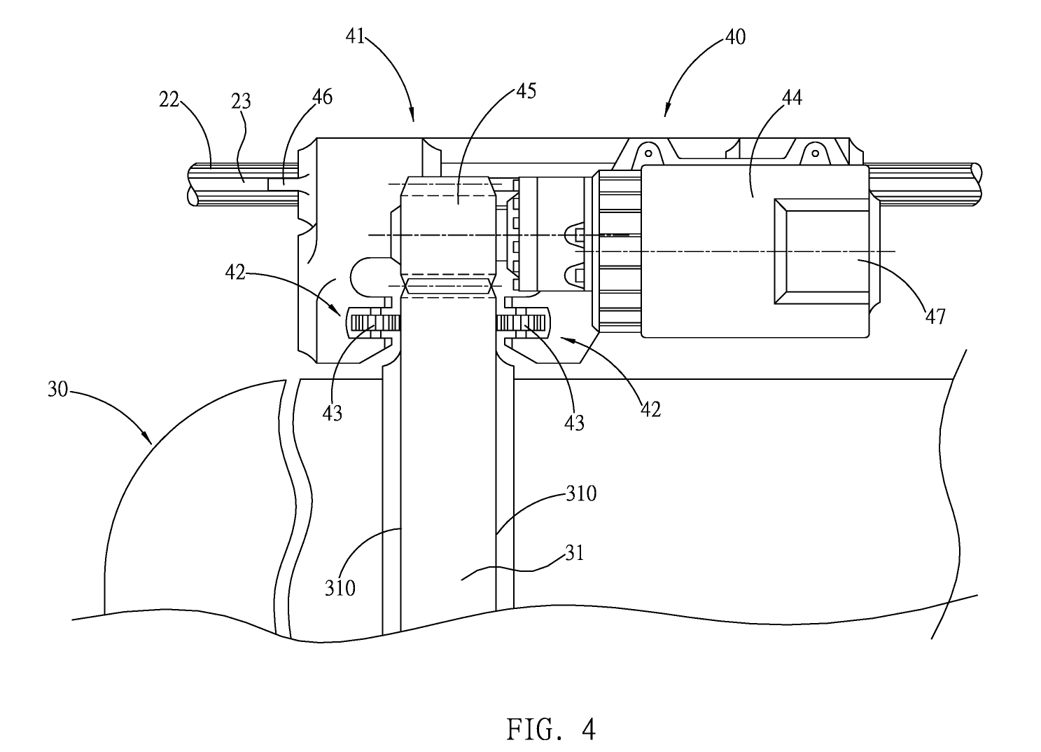

Referring to FIG. 4, the driving unit 40 is provided with a slide base 41 which slides on the longitudinal line of the slide bar 22. The slide base 41 is provided with a positioning slide block 46 which slides into a positioning chute 23 concaved on a surface of the slide bar 22 longitudinally. Therefore, when a power motor 44 of the driving unit 40 generates power to act onto the output wheel 45 which is in turn linked to the passive structure 31 of the counterweight unit 30, at a moment of transmitting the power, as the positioning slide block 46 is limited by the positioning chute 23, a counteract torque generated by the output wheel 45 will be absorbed by the positioning chute 23, allowing the driving unit 40 to be linked with the passive structure 31 radially at the angular position fixed by the slide bar 22.

For the slide base 41 of the driving unit 40, the front position and the rear position of the passive structure 31 provided by the counterweight unit 30 are provided respectively with a sliding part 42 which can be a sliding element such as a pulley. The sliding part 42 shears on a wheel side 310 on a front side or a rear side of the passive structure 31. The function of the sliding parts 42 is that when the driving unit 40 outputs power to drive the counterweight unit 30 to rotate, the hollow part 32 of the counterweight unit 30 (as shown in FIG. 3) will move rotatably on the lead screw 24, forming a displacement. Therefore, the driving unit 40 also has to displace along with the hollow part 32. On the other hand, for the opposite sliding parts 42 to slide on the opposite wheel sides 310 of the passive structure 31, when the counterweight unit 30 displaces, it is similarly that the sliding parts 42 drive the slide base 41 to slide in a reverse direction, and the entire driving unit 40 will also displace along with the counterweight unit 30 to wait at the linking position, keeping the gnawing relation between the output wheel 45 and the passive structure 31.

As shown in FIG. 3 and FIG. 4, each load bracket 20 is also provided with an angular position sensing controller 47 to sense the angle of rotation. When the load bracket 20 is in the direction along which the counterweight unit 30 displaces, such as at 6 o'clock, the angular position sensing controller 47 will turn on working energy to command the driving unit 40 to drive the counterweight unit 30 to displace.

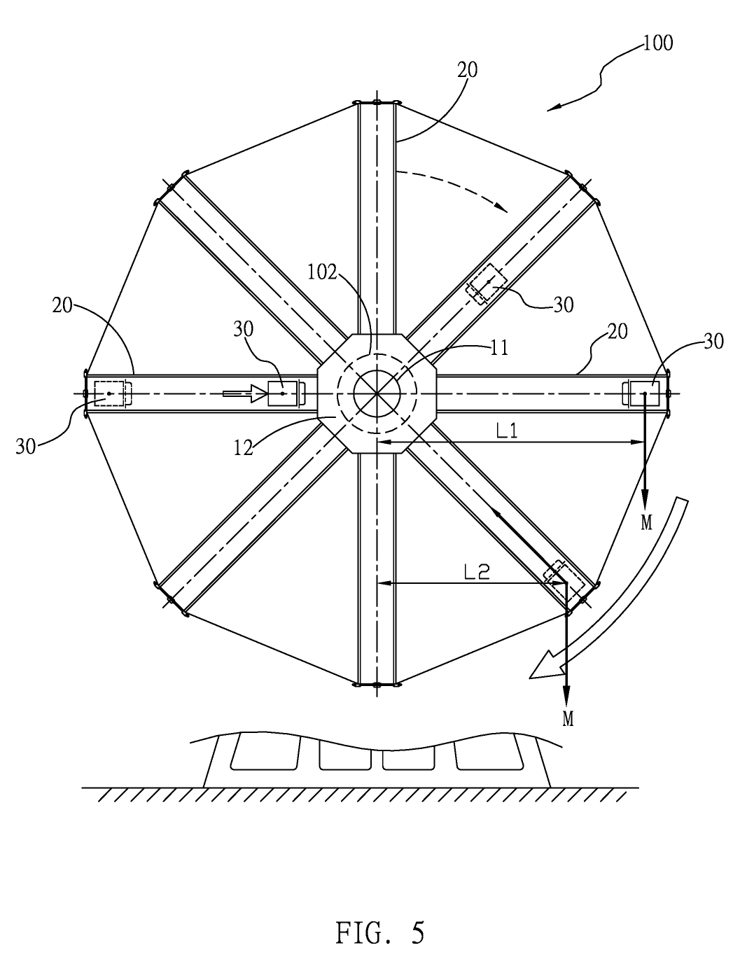

Referring to FIG. 5, by using the abovementioned structures, a force arm will be formed between the mass M of the counterweight unit 30 and the center of the central shaft 11, and the resulted moment of force will act onto the power output shaft 102. As shown in the drawing, when the load bracket 20 is in the direction of 3 o'clock, the counterweight unit 30 is affected by gravity to result in a longest force arm L1, thereby acquiring a largest moment of force to act onto the central shaft 11 or the power output shaft 102. As the load brackets 20 are installed symmetrically, for the load bracket 20 in the direction of 9 o'clock, the associated counterweight unit 30 will need to come closer to the wheel pivot 12, so that a shortest force arm is formed between the counterweight unit 30 in the direction of 9 o'clock and the central shaft 11, thereby avoiding the consumption of positive moment of force. At this time, the torque generated by the counterweight unit 30 in the direction of 3 o'clock through the longest force arm L1 will be responsible for the torque of the counterweight unit 30 in the direction of 9 o'clock relative to gravity, and the remaining high torque will act onto the power output shaft 102.

When the load bracket 20 in the direction of 3 o'clock operates clockwise to the location of 4 o'clock and 30 minutes, the horizontal distance between the mass M of the counterweight unit 30 and the central shaft 11 is reduced to form a shorter force arm L2. With the generation of component of force caused by the change in the angular position of the load bracket 20, the counterweight unit 30 will leave from the direction of 3 o'clock. When the counterweight unit 30 approaches the direction of 6 o'clock, the action force of the counterweight unit 30 will decrease to zero. At this time, the symmetric load bracket 30 that moves to the direction of 12 o'clock will not result in positive energy to the power output shaft 102 either. However, if the load bracket 20 moves a little further, such as to the direction of 1 o'clock and 30 minutes, then the counterweight unit 30 will be acting, and the system can utilize plural load brackets 20 to allocate a better moment of force from the direction of 1 o'clock and 30 minutes to the direction of 4 o'clock and 30 minutes.

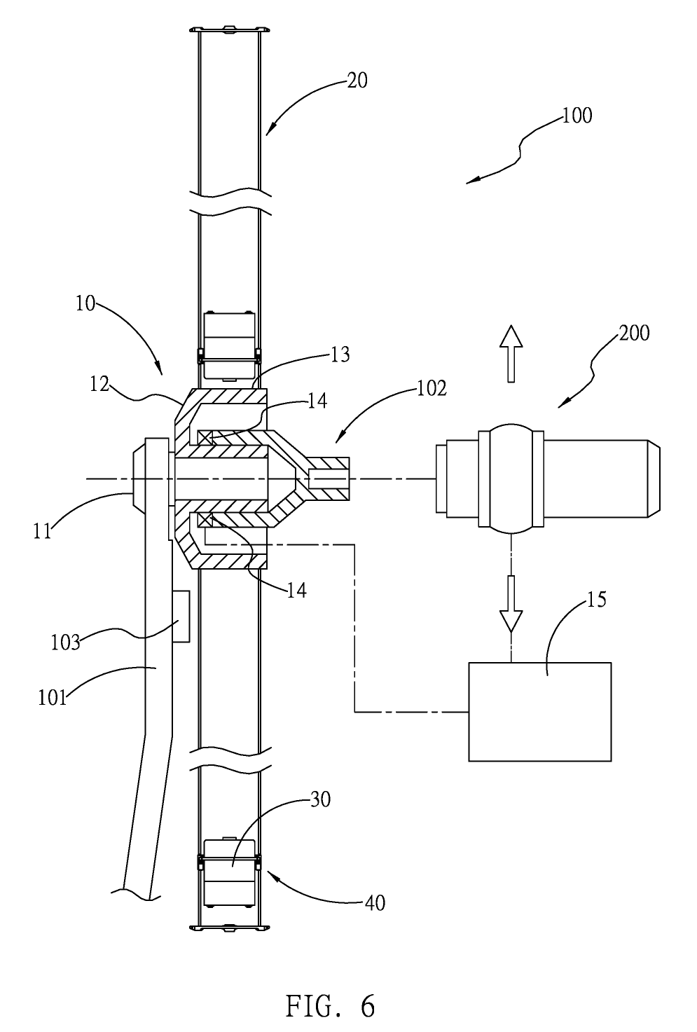

Referring to FIG. 6, the central shaft 11 of the operation mechanism 100 is supported by an upper end of the upright base 101, allowing the axis of the central shaft 11 to be parallel to the horizontal line on ground. An outer circumference of the central shaft 11 provides for the emplacement of a wheel pivot 12, and an end of the wheel pivot 12 is linked outward with a power output shaft 102. The combination part 13 of the wheel pivot 12 is assembled outward with the load bracket 20, and an interior of the main body of a pivoting unit 10 is further provided with a contact pivot 14 which operates by rotation.

Through the abovementioned operation, the power output shaft 102 generates energy outward to link with an energy conversion unit 200. The energy conversion unit 200 can output mechanical work, hydraulic pressure or electricity. For electricity, the energy conversion unit 200 is an electromechanical device, and the generated energy can be transmitted to an energy processing unit 15 and then is fed back reversely to the operation mechanism 100. The path is that the energy processing unit 15 transmits the energy to the contact pivot 14, and then the contact pivot 14 transmits working electricity by a fixed control unit 103, operating the driving unit 40 to drive the counterweight unit 30 to displace; whereas, the contact pivot 14 is an ordinary armature.

The abovementioned operation of control unit 103 can be also used as an auxiliary operation by touching the angular position sensing controller 47 as shown in FIG. 4. In this kind of design, the angular position sensing controller 47 can be a circuit of self-computing. When the angular position sensing controller 47 is touched at a fixed position by the control unit 103, the computation will start and a driving condition will be issued to the driving unit 40 to change the amount of displacement or the rate of displacement of the counterweight unit 30.

In the beginning of system start and before generating energy, an external force can be provided to the driving unit 40 to execute driving energy to displace the counterweight unit 30. When the system operates to achieve a state of self-feedback, the external force can be released. The external force, such as electric energy, can be stored in the energy processing unit 15 in advance, and is fed in to initiate the system operation.

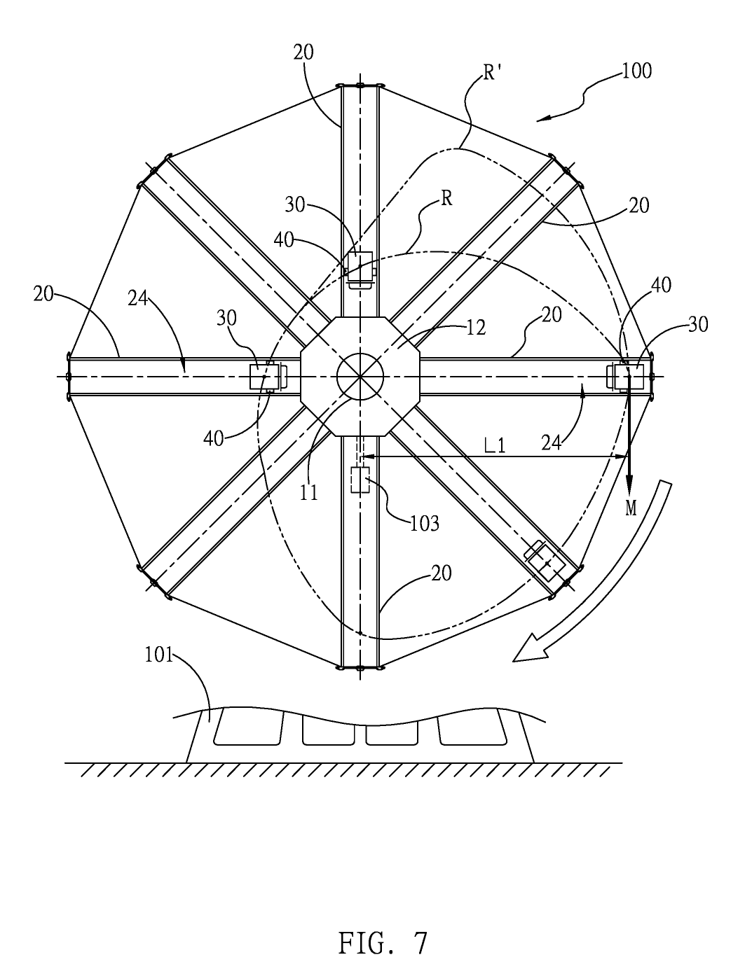

Referring to FIG. 7, the control unit 103 can be fixed in the structure body of the upright base 101, or an end of the central shaft 11 can be extended outward to link with the control unit 103, allowing the control unit 103 to be fixed at an angular position of working. The control unit 103 can use image detection or computation to sense or predict the angular position of operation for each load bracket 20. When a load bracket 20 is in the direction of 12 o'clock, the driving unit 40 that drives the counterweight unit 30 can be commanded to move toward an outer end of the load bracket 20 (the outer direction of system operation). The movement is at a largest speed, so that when the load bracket 20 reaches the direction of, like 1 o'clock and 30 minutes, the counterweight unit 30 can at least be pushed into a half stroke of the load bracket 20. When the load bracket 20 reaches the direction of 3 o'clock, the counterweight unit 30 will be pushed to the outermost end.

Basically, the control unit 103 can sense or predict the load bracket 20 that enters into the direction of 6 o'clock. The load bracket 20 in the direction of 6 o'clock rotates clockwise, and at this time, the control unit 103 will quickly command the driving unit 40 to drive the associated counterweight unit 30 to retreat toward the central shaft 11 as close as possible. The best scenario is that when the load bracket 20 reaches the direction of 9 o'clock, the associated counterweight unit 30 is abutted on the wheel pivot 12.

The effective timing of the abovementioned counterweight unit 30 is that the load bracket 20 is at the outermost end when it is in the direction of 3 o'clock, which will result in the largest torque. When the load bracket 20 is in the direction of 9 o'clock, the counterweight unit 30 will move closer to a side of the wheel pivot 12, which reduces the generation of a reverse torque.

The load brackets 20 of the system are distributed radially and isotropically. When the load bracket 20 is in the direction of 12 o'clock to 6 o'clock, an effective torque will be generated. On the other hand, when the load bracket 20 is in the direction of 6 o'clock to 12 o'clock, a load will be resulted. Therefore, by adjusting the counterweight unit 30, plural symmetric load brackets 20 can be kept in the direction of 12 o'clock to 6 o'clock, resulting in a positive moment of force. That moment of force can satisfy the counteraction to the reverse moment of force in the direction of 6 o'clock to 12 o'clock, and the operation mechanism 100 can operate perpetually.

For the abovementioned displacement path R, when the load bracket 20 is in the direction of 11 o'clock, the counterweight unit 30 can begin to move outward. When the load bracket 20 reaches the direction of 1 o'clock, the counterweight unit 30 will be positioned on the outer end of the load bracket 20, allowing the counterweight unit 30 to result in a torque onto the wheel pivot 12. Therefore, the displacement path R will be deformed into a displacement path R′, and large energy can be generated when the load bracket 20 is in the direction of 12 o'clock to 6 o'clock.

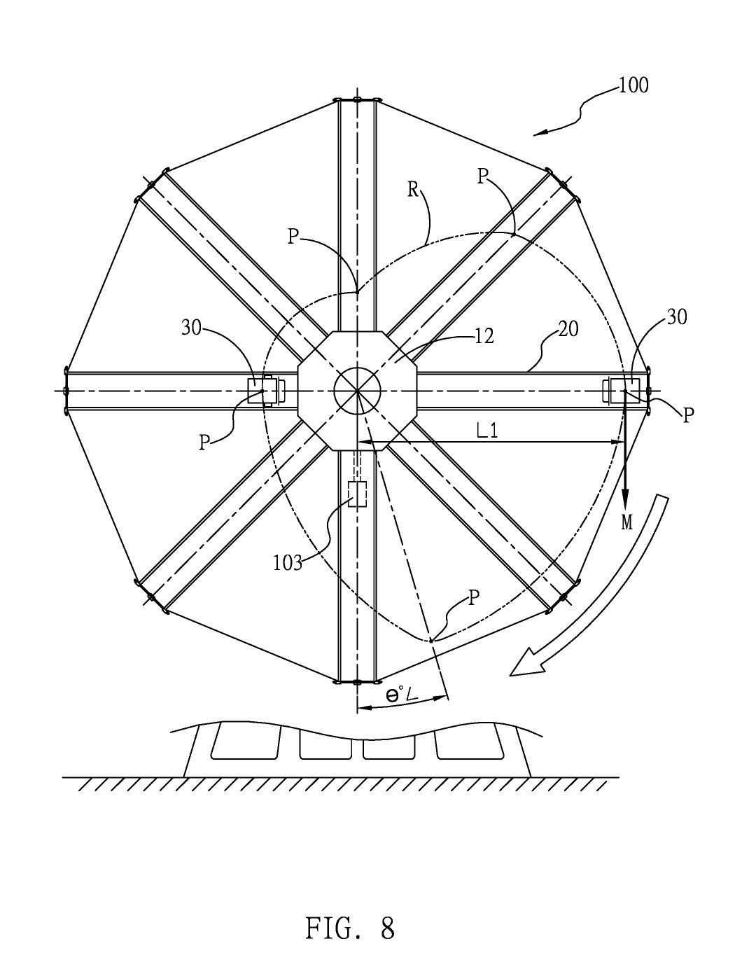

Referring to FIG. 8, it shows that when a single load bracket 20 of the counterweight unit 30 operates by one turn, the front and rear position of the counterweight unit 30 relative to the longitudinal centerline of the load bracket 20 will change by a variety of degree depending upon angles. For a preferred embodiment, when the load bracket 20 is in the direction of 3 o'clock, the position point P of the counterweight unit 30 will reach the outermost end following the outward displacement of the counterweight unit 30; whereas, when the load bracket 30 is in the direction of 3 o'clock to 4:30, the position point P of the counterweight unit 30 will not need to change. However, when the load bracket 20 is about to enter into the direction of 6 o'clock, the control unit 103 of the system will command the counterweight unit 30 to move toward the wheel pivot 12, with the best condition being that the counterweight unit approaches the wheel pivot 12 very quickly, allowing the counterweight unit 30 to be abutted on the wheel pivot 12 upon reaching the direction of 9 o'clock. The position point P of the counterweight unit 30 in the direction of 9 o'clock to 12 o'clock is the load, and therefore, the position of the counterweight unit 30 does not need to change. After leaving the direction of 12 o'clock, the counterweight unit 30 will be pushed out quickly, and a track formed by the traveling of plural position points P will be simulated as a displacement path R, which is in a shape of heart.

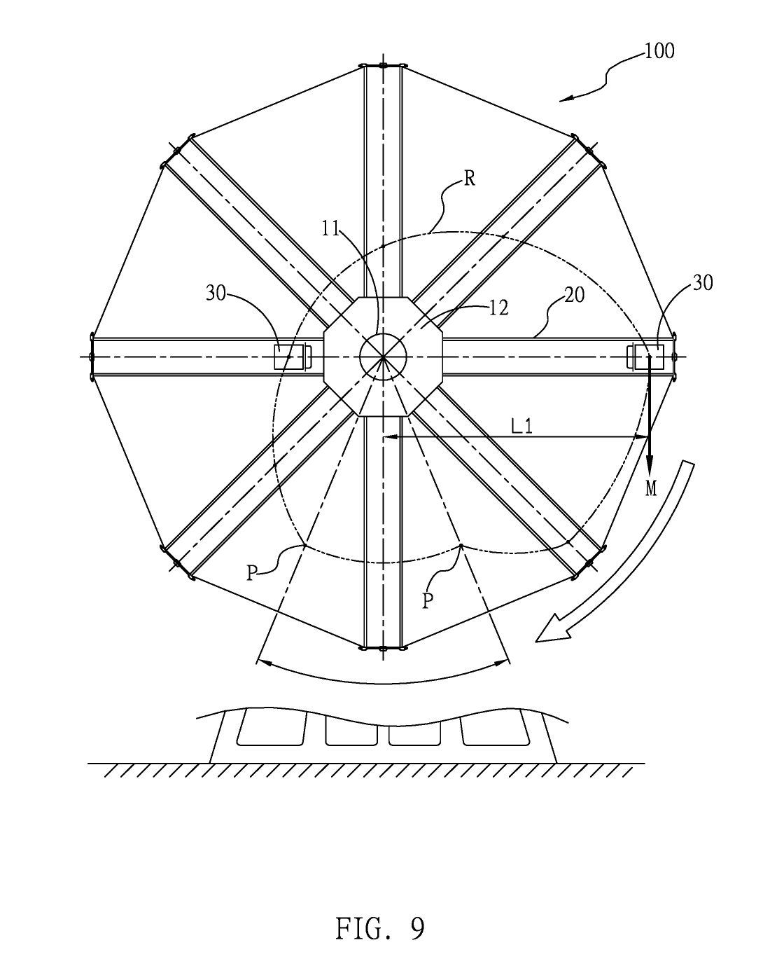

Referring to FIG. 9, it shows another implementation of the displacement path R of the operation mechanism 100, according to the present invention, wherein the position point P of the counterweight unit 30 will not need to change in the direction of 5 o'clock to 7 o'clock. The position point P in the direction of 7 o'clock to 9 o'clock, on the other hand, is changed quickly, allowing the counterweight unit 30 to be abutted on the wheel pivot 12. After reaching the direction of 12 o'clock, the counterweight unit 30 will be pushed out quickly, so that the counterweight unit 30 can be disposed on the outermost end of the load bracket 20. Therefore, by the irregular curve, the force arm of the counterweight unit 30 can be changed, and the energy that drives the counterweight unit 30 can be adjusted to save energy.

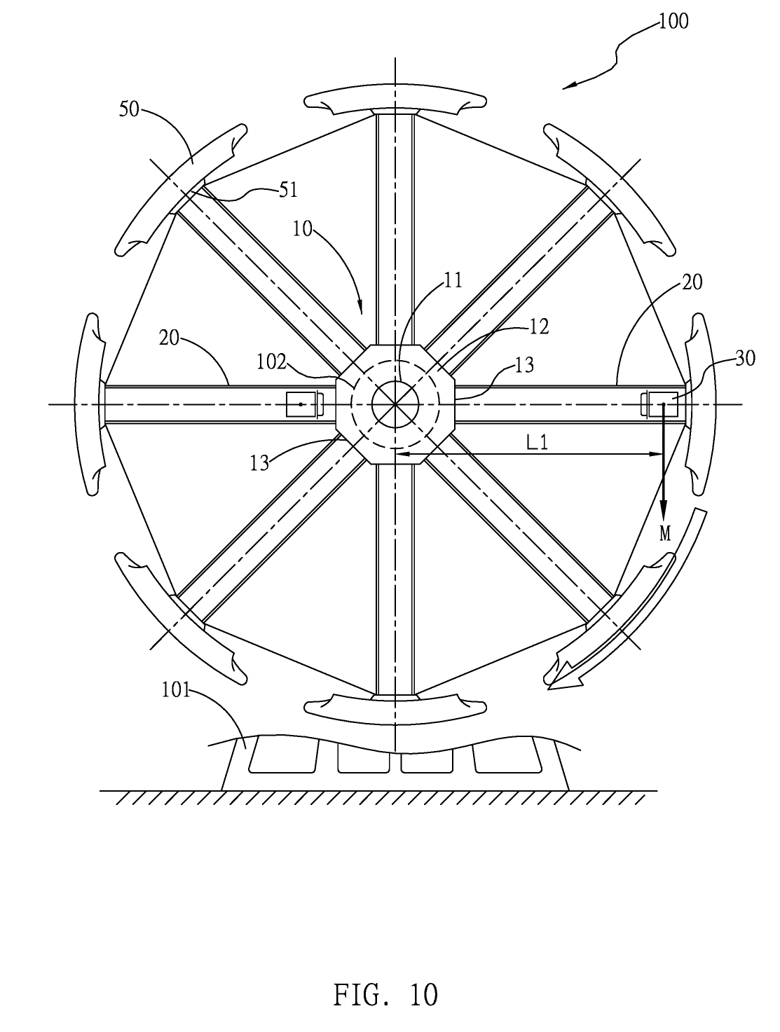

Referring to FIG. 10, for the system to fight against the abrupt counteraction, such as when a generator operates and in the process of exciting the mechanical movement of current by the cutting of each coil to the magnetic field, a load per unit time will occur against the external force, the system is at the position of a largest operation radius and a counterweight to assist in the inertia of gyration can be allocated. For example, an inertial counterweight unit 50 with equal mass and specification can be disposed on an outer end of each load bracket 20, in an equal radius. An interior side of the inertial counterweight unit 50 is a combination part 51 which is combined with a tail end of the load bracket 20. Being subjected to the law of motion, the wheel pivot 12 of the central shaft 11 can be existed with an inertial torque during system operation.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A power generating system operated by gravity, being a self-perpetuating system which is achieved by gravity to enable mass to result in a moment of force, with that the moment of force is converted into energy which is then fed back to the system to assist in the dynamic operation, and that redundant energy outputs electricity outward, comprising an operation mechanism which is provided with a fixed central shaft, with that the central shaft is supported by an upright base, the axis of the central shaft is parallel to the horizontal line on ground, and the operation mechanism further includes:
a wheel pivot being movably disposed on the central shaft, the wheel pivot being distributed isotropically with plural load brackets in a long shape, and an axial end of the wheel pivot being linked with a power output shaft;
plural counterweight units in a circular shape, and the counterweight units being distributed in each load bracket and displacing along the front and rear side of the longitudinal centerline of the load bracket;
plural driving units, the driving units being movable on the load brackets and driving the associated counterweight unit to displace depending upon the change in the angular of rotation of the load bracket;
an energy conversion unit being linked by the power output shaft to convert into electric energy; and
an energy processing unit which processes the energy transmitted by the energy conversion unit and feeds back the energy to the driving unit through a contact pivot.

2. The power generating system operated by gravity, according to claim 1, wherein the operation mechanism is provided with a fixed control unit which determines the change in angular position of each load bracket, controls the associated driving unit of the load bracket, and drives the associated counterweight unit to displace in parallel with the front and rear position on the longitudinal centerline of the load bracket.

3. The power generating system operated by gravity, according to claim 1, wherein an interior of each load bracket is provided associatively with an angular position sensing controller to sense the angle of rotation and command the associated driving unit to work.

4. The power generating system operated by gravity, according to claim 1, wherein the energy conversion unit and the driving unit are electromechanical devices.

5. The power generating system operated by gravity, according to claim 1, wherein the longitudinal centerline of the load bracket is provided with a fixed lead screw to provide for rotatably connecting the center of the counterweight unit along the axial direction.

6. The power generating system operated by gravity, according to claim 1, wherein the longitudinal centerline of the load bracket is provided with a fixed lead screw, and a slide bar is disposed on a parallel side of the lead screw to constitute an infrastructure of the load bracket, with that the slide bar provides for slidingly emplacing the driving unit.

7. The power generating system operated by gravity, according to claim 6, wherein the slide bar is provided longitudinally with a positioning chute which provides for a fixation of the driving unit relative to the radial orientation of the slide bar.

8. The power generating system operated by gravity, according to claim 1, wherein a circumference on a largest radius of the counterweight unit is annularly provided with a passive structure which is driven by an output wheel of the driving unit.

9. The power generating system operated by gravity, according to claim 1, wherein the driving unit is provided with a slide base, the slide base is disposed on the slide bar of the load bracket, the slide base is provided with a power motor to turn on the energy processing unit, and the slide base is extended with a sliding part on a side opposite to the counterweight unit, with that the sliding part slides radially on the end of the wheel side in front of and at back of the passive structure.

10. The power generating system operated by gravity, according to claim 1, wherein an outer end of each load bracket is combined with an inertial counterweight unit in a same specification.
